(19) United States
(12) Patent Application Publication
(10) Pub. No.: US 2019/0131819 A1
(43) Pub. Date: May 2, 2019

(54) SOLAR PANEL HOUSING FOR A PARKING METER AND METHODS OF USE THEREFOR

(71) Applicant: Global Integrated Solutions Limited, Albany (NZ)

(72) Inventor: Jonathan Donal Bell, Auckland (NZ)

(21) Appl. No.: 16/164,495

(22) Filed: Oct. 18, 2018

(30) Foreign Application Priority Data
Oct. 30, 2017 (NZ) 736795

(51) Int. Cl. H02J 7/35; G07F 17/24

(52) U.S. Cl. CPC H02J 7/35; G07F 17/248

(57) ABSTRACT

The present disclosure encompasses to solar power charging system adapted for use with a parking meter, and methods of using this solar power charging system. Also encompassed are assemblies and assembly methods for the solar power charging system.

### RELATED APPLICATION

The present application claims the benefit of New Zealand provisional application number 736795 filed on 30 Oct. 2017, the entire contents of which are incorporated herein by reference.

### FIELD OF THE INVENTION

The present disclosure relates to solar power charging system, including a housing with one or more solar panel, adapted for use with a parking meter. The disclosure relates also to methods of assembling and utilising this solar power charging system.

### BACKGROUND OF THE INVENTION

Parking meters require power for one or more user interfaces, illumination sources, and payment systems. In particular, power is required for a parking meter to control visible displays, touch screens, keyboards, push buttons, exterior or interior lighting, payment card detection, coin detection, amongst various other functional or design features.

Traditionally, power input for parking meters have come from standard batteries, which must be replaced when fully discharged. This replacement is a labour- and time-intensive process, and quite costly over time. It also generates battery waste materials, which are damaging to the environment. More recently, power input for parking meters has been generated from small solar panels that fitted to the top of the meter. However, such solar panels are quite limited in size, and this greatly restricts the power that can be generated.

Thus, there is a need for an improved solar power charging system to receive energy through solar power, and to supply and/or supplement power for a parking meter.

### SUMMARY OF THE INVENTION

In one aspect, the invention encompasses a solar panel charging system for a parking meter comprising a housing that is configured as a sleeve for a parking meter pole or post, wherein the housing comprises a plurality sides, wherein at least one of the plurality of sides comprises a solar panel for absorbing solar energy, wherein the solar panel is in electrical communication with a power source for the parking meter, and wherein the electrical communication provides a power supply for the parking meter.

In various aspects:

The housing comprises at least four vertical or essentially vertical sides.

The housing comprises at least two solar panels.

The housing comprises one or more slots for each solar panel.

The electrical communication comprises an electrically conductive wire or wireless communication.

The electrical communication is controlled by a solar panel controller.

The electrical communication is controlled by a main controller for the parking meter.

The solar panel provides a sole supply of power for the parking meter.

The solar panel provides a supplementary supply of power for the parking meter.

The power source for the parking meter comprises one or more batteries.

The parking meter comprises one or more additional solar panels on a head portion of the parking meter.

The housing comprises extruded aluminium.

The housing comprises extruded plastic.

The housing is engaged with a base.

In one other aspect, the invention encompasses a method for providing a power supply for a parking meter comprising installing the housing of any one or the preceding aspects to a parking meter pole or post, and facilitating the electrical communication between the solar panel and the power source for the parking meter.

In various aspects:

The electrical communication comprises an electrically conductive wire or wireless communication.

The electrical communication is controlled by a solar panel controller.

The electrical communication is controlled by a main controller for the parking meter.

The solar panel provides a sole supply of power for the parking meter.

The solar panel provides a supplementary supply of power for the parking meter.

The power source for the parking meter comprises one or more batteries.

The parking meter comprises one or more additional solar panels on a head portion of the parking meter.

The foregoing brief summary broadly describes the features and technical advantages of certain embodiments of the present invention. Further technical advantages will be described in the detailed description of the invention and examples that follows.

Novel features that are believed to be characteristic of the invention will be better understood from the detailed description of the invention when considered in connection with any accompanying figures and examples. However, the figures and examples provided herein are intended to help illustrate the invention or assist with developing an understanding of the invention, and are not intended to limit the invention's scope.

### BRIEF DESCRIPTION OF THE DRAWINGS

FIG. 1: Diagram showing a perspective view of an embodiment of the solar panel housing, which is adapted to fit over the pole for a parking meter.

FIG. 2: Diagram showing a perspective view of an embodiment of the solar panel housing, which is adapted to engage with the head for a parking meter.

FIG. 3: Diagram showing a perspective view of an embodiment of the solar panel housing, which is installed onto the pole for a parking meter. The front and right sides of the parking meter are shown.

FIG. 4: Image of a solar panel positioned on top of a parking meter. The rear side of the parking meter is shown at left. The front side of the parking meter is shown at right.

FIG. 5: Diagram showing a perspective view of an embodiment of a parking meter, without the solar panel housing. The front and right sides of the parking meter are shown.

### DETAILED DESCRIPTION OF THE INVENTION

The following description sets forth numerous exemplary configurations, parameters, and the like. It should be recognised, however, that such description is not intended as a limitation on the scope of the present invention, but is instead provided as a description of exemplary embodiments.

### Definitions

In each instance herein, in descriptions, embodiments, and examples of the present invention, the terms “comprising”, “including”, etc., are to be read expansively, without limitation. Thus, unless the context clearly requires otherwise, throughout the description and the claims, the words “comprise”, “comprising”, and the like are to be construed in an inclusive sense as to opposed to an exclusive sense, that is to say in the sense of “including but not limited to”.

As used herein a “parking meter” means any device for accepting payment for parking at one or more parking bays. A parking meter includes, in general aspects, a head portion, a pole or post or other type of stand, and optionally, a base. The “head” of a parking meter refers to the interactive portion that includes, for example, one or more display means, and one or more payment processing means.

The directional terms “left” and “right”, “front” and “rear”, “top” and “bottom”, and “vertical”, as used herein are defined relative to the parking meter, given the viewpoint of a user engaging with the parking meter, for example, to make payment, to view time remaining, etc.

“Essentially vertical” encompasses an orientation that is about 1° to about 10° out from true vertical. “Essentially circular” encompasses a perimeter that is about 1% to about 10% longer or shorter than a true circle. “Essentially identical” encompasses a dimension (e.g., height or width, for example, width ‘A’) that is about 1% to about 10% greater or lesser than the dimension being compared (e.g., height or width, for example, width ‘B’).

### Solar Panel Housing for a Parking Meter and its Assembly and Use

The present disclosure encompasses a solar power charging system for supplying and/or supplementing power for a parking meter. The solar power charging system includes a housing with one or more solar panel, which is adapted for use with a parking meter. The solar panel charging system provides or enhances the solar input provided to the parking meter, to generate energy required for parking meter functionality.

In a particular embodiment, the housing for the solar power charging system comprises a plurality of sides. The housing for the solar power charging system may be constructed with planar sides, including but not limited to, cuboid, trapezoid, pyramidal, pentagonal, or octagonal configurations. The planar sides may be elongated in their height, as described further below. The planar sides may be vertical or essentially vertical in orientation. Alternatively, the housing for the solar power charging system may have sides that are curved, for example, including but not limited to arc, cylinder, cone, or frustum configurations. The curved configurations may be elongated in their height, as described further below. The curved sides may be vertical or essentially vertical in their orientation. The curved configurations may include a perimeter that is circular, a perimeter that is essentially circular, a perimeter that comprises one or more portions of a circle, a perimeter that is elliptical, or a perimeter that comprises one or more portions of an ellipse. The housing may include any combination of planar and curved portions. This includes, but is not limited to, cuboids with concave, convex, or clipped corners, boat configurations, and capsule configurations.

In particular embodiments, the sides of the solar power charging system may be elongated in height, to maximise solar input. Specifically, the elongated sides may be configured to fit over the pole or post of the parking meter. The housing may thereby be designed as a solar sleeve for a parking meter. For example, it will be possible to retrofit pre-existing parking meters by removing the parking meter head and sliding the housing over the parking meter pole or parking meter post, and after this, reattaching the parking meter head. It will also possible to fit newly constructed parking meters by sliding the housing over the parking meter pole or post prior to engagement of the parking meter head.

Amongst the various housing embodiments, the orientation of the housing on the parking meter pole or parking meter post may be planned to maximise solar input. As one particular embodiment, cuboid shaped housing may be utilised, having four vertical or essentially vertical sides that are elongated along the vertical plane. For cuboid shaped housing, each of the vertical or essentially vertical sides may be essentially identical in height, and each of the vertical sides may be essentially identical in width. Alternatively, one or more of the sides may comprise one or more different dimensions as compared to another side.

The housing for the solar power charging system may be constructed from one or more durable materials. In various embodiments, one or more metals may be used to construct the housing, including aluminium and steel. As other embodiments, one or more plastic materials may be used, for example, hard plastics. Any combination of metal and plastic materials may be used. The construction may be achieved by extrusion methods, for example, aluminium or plastic extrusion. Construction may also be achieved by casting, moulding, or direct manipulation of the housing materials. This manipulation includes, but is not limited to, various fabrication methods such as soldering, brazing, cutting, boring, milling, shaping, drilling, bending, and gluing. Each of the sides for the housing may be constructed individually, to be assembled after construction, or two or more sides may be constructed in tandem.

The housing may be fitted with one or more solar panels, to absorb solar energy. The solar panels will comprise a series of solar cells. The solar panels may be fitted by slots in the housing or by any other engagement means. These include, but are not limited to, one or more openings such as notches or holes, one or more protrusions such as lips, nibs, or tabs, one or more fixings such as hooks, pins, screws, bolts, or rivets, one or more adhesives such as glues, gums, epoxies, or resins, amongst others. Different combinations of engagement means may be used. The fitting may be permanent or may allow removal for repairs or replacement. Depending on the particular construction, it may be possible to direct the solar panel(s) towards the sun to maximise solar input. For example, one or more of the solar panels (or one or more of the solar cells) for the housing may be adapted to tilt or swivel to provide for optimal energy capture. One or more of the sides may include a perimeter around the solar panel, such as a rim, ridge, shoulder, or margin.

In various embodiments, the housing may have one side comprising solar cells, two sides comprising solar cells, three sides comprising solar cells, four sides or more comprising solar cells, or all sides of the housing comprising solar cells. In particular embodiments, one or more of the sides of the housing may be overlaid, i.e., essentially covered, with solar cells. Alternatively, one or more of the sides of the housing may have a portion that comprises solar cells, e.g., the top one-quarter, top one-third, top one-half, or any portion between. In particular embodiments, cuboid housing may have two sides comprising solar cells, three sides comprising solar cells, or four sides comprising solar cells. It will be understood from the description above that the solar cells can be incorporated as one or more solar panels.

The one or more solar panels on the housing will be in electrical communication with a power source for the parking meter. For example, the solar panel on the housing may be connected to a diode, or may be engaged with an electrically conductive element. The electrically conductive element can include, but is not limited to, a circuit board, an electrically conductive wire, a conductor, or wireless communication. In use, an electrical current generated by a solar panel may be transferred through the electrical conductor to a regulating circuit. As already noted, the power may be wirelessly transmitted from a solar panel. Wireless charging may include inductive charging. In particular embodiments, one or more of the solar panels may be connected to the regulating circuit that provides, supplements, and/or maintains the parking meter's power levels, e.g., battery charge levels.

The energy output from the solar panels may be regulated (e.g., turned on/turned off or turned up/turned down) by one or more electrical controllers. In certain embodiments, the one or more solar panels on the housing may be configured to engage with the main controller of the parking meter. For example, individual solar panels or one or more groups of solar panels may be in electrical communication with the main controller. This electrical communication may be direct or indirect. In particular, electrical communication with the main controller may be mediated by a subsidiary controller for the one or more solar panels, e.g., a solar sleeve controller. The solar sleeve controller may direct energy output to the main controller. In turn, the main controller may direct energy output to the parking meter or the parking meter power source, and facilitate the charging function for the system, as described herein. It may also be useful for the solar sleeve controller to provide energy directly to the parking meter or parking meter power source. Where multiple solar panels are used, it may be suitable for each panel to have its own controller. Alternatively, multiple solar panels may share a controller.

In one embodiment, the solar panels on the housing may provide the sole supply of solar energy to the parking meter. In alternative embodiments, the solar panels on the housing may boost the solar energy provided by other solar panels arranged on the parking meter. In this way, the housing can be used as a supplementary supply of power for the parking meter. As a particular embodiment, the parking meter may comprise one or more solar panels on the top of the meter, in addition to the solar panels on the housing. In certain situations, it may be preferable to direct one or more of these solar panels towards the sun, to maximise solar input. The solar energy received by the solar panels may be used to run and/or charge the power source for the parking meter. The power source for the parking meter may include one or more power storage devices, including one or more batteries.

The housing may be engaged with head of the parking meter by one or more engagement means. Such means include, but are not limited to, one or more openings such as slots or holes, one or more protrusions such as tabs, lugs, or knobs, one or more fixings such as hooks, pins, screws, bolts, or rivets, one or more adhesives such as glues, gums, epoxies, or resins, amongst others. Different combinations of engagement means may be used. It is expected that any engagement means will allow for electrical communication between the housing and the head of the parking meter, as described herein. The housing may also be engaged with a base for the parking meter by one or more engagement means. Various engagement means and their combinations are disclosed above and elsewhere herein. In a particular aspect, the housing may be constructed to include an integrated base. For example, the housing may be made by fabrication methods or extrusion methods to include a base. Alternatively, the base may be constructed separately from the housing, and subsequently engaged with the housing. It is also possible that the housing may be engaged with a base that is pre-existing on the parking meter.

It will be understood that a base may be helpful for increasing the stability of the housing for the parking meter. Other means may also be used to assist with stabilisation. For example, a bottom portion of the housing may be configured to be flared (e.g., a structure that is angled or curved outward) as compared to the top portion of the housing. As a further example, a bottom portion of the housing may include a margin of material (e.g., a thickened or widened structure) that assists with stability. Such means may be employed in lieu of a base or in addition to a base, as described herein.

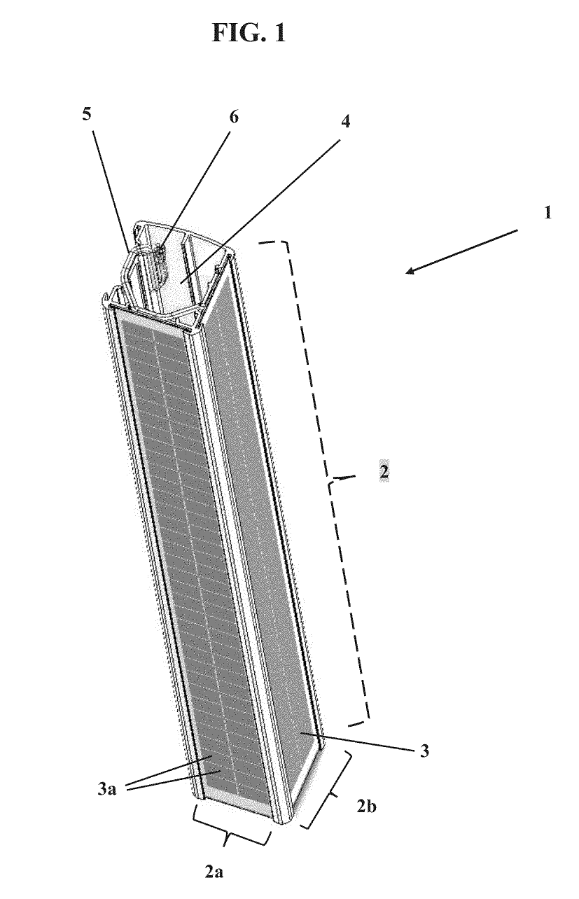

Referring to the drawing of FIG. 1, the solar power charging system 1 in this exemplification is configured to include a housing 2, with vertical sides 2a and 2b (shown), as well as 2c, and 2d (not shown). The vertical sides of the housing 2a and 2b (shown), as well as 2c and 2d (not shown), each include a solar panel 3, which is comprised of a series of solar cells 3a. The interior of the housing 4, is adapted to hold at least one electrically conductive element 5, from at least one solar panel 3. The electrically conductive element 5 is also in communication with an adaptor 6, which allows a connection to be established to the main controller or other controlling device in the head of the parking meter (not shown).

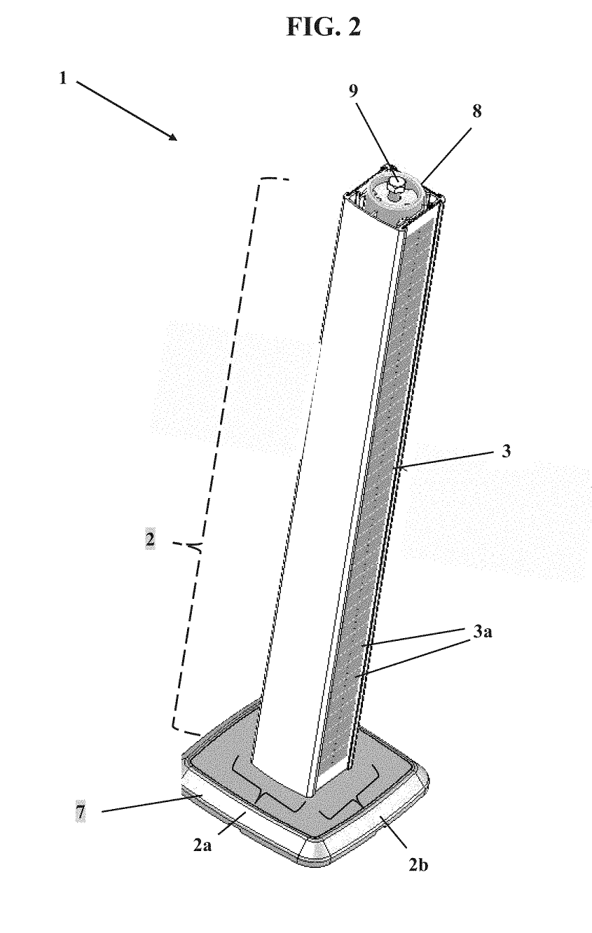

Referring to the drawing of FIG. 2, the solar power charging system 1 in this exemplification is configured to include a housing 2, with vertical sides 2a and 2b (shown), as well as 2c, and 2d (not shown). The vertical side 2b includes a solar panel 3, which is comprised of a series of solar cells 3a. The vertical side 2a, as well as the vertical sides 2c and 2d (not shown) do not include solar panels. The top of the housing 2 includes an electrical interface 8, which allows an electrical connection to be established to the head of the parking meter (not shown). The top of the housing 2 also includes an engagement means 9 for engaging with the head of the parking meter (not shown). The housing 2 in this embodiment is installed over the parking meter pole (not shown). At its bottom end, the housing 2 is seated on the base 7 for the parking meter.

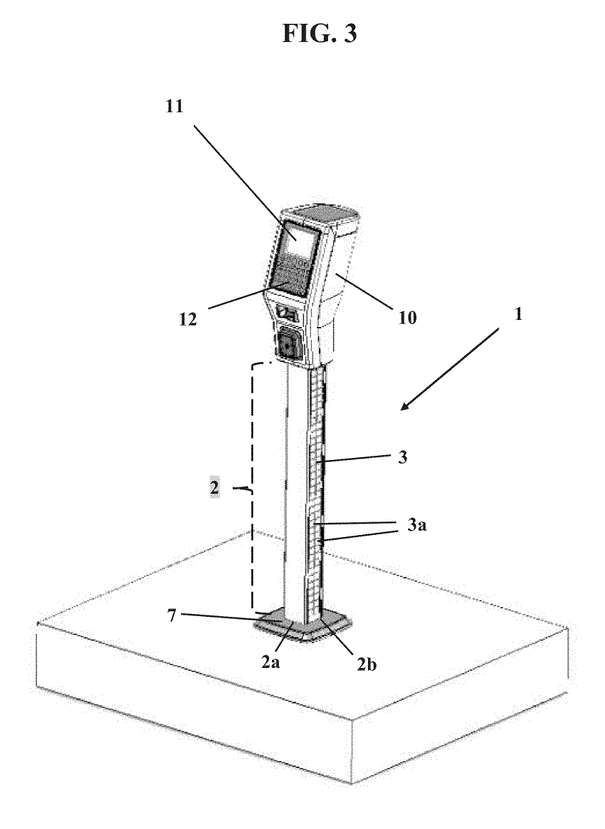

Referring to the drawing of FIG. 3, the solar power charging system 1 in this exemplification is configured to include a housing 2, with vertical sides 2a and 2b (shown), as well as 2c, and 2d (not shown). The vertical side 2b and the vertical side 2d (not shown) each include a solar panel 3, which is comprised of a series of solar cells 3a. The vertical side 2a, as well as the vertical side 2c (not shown) do not include solar panels. The housing 2 is engaged at its top end with the head 10 of the parking meter, which includes a screen 11 and keyboard 12. The housing 2 is seated at its bottom end on the base 7 for the parking meter. The top of the housing includes an electrical interface 8, which allows an electrical connection to be established to the head of the parking meter (not shown). The top of the housing 2 also includes an engagement means 9 for engaging with the head of the parking meter (not shown).

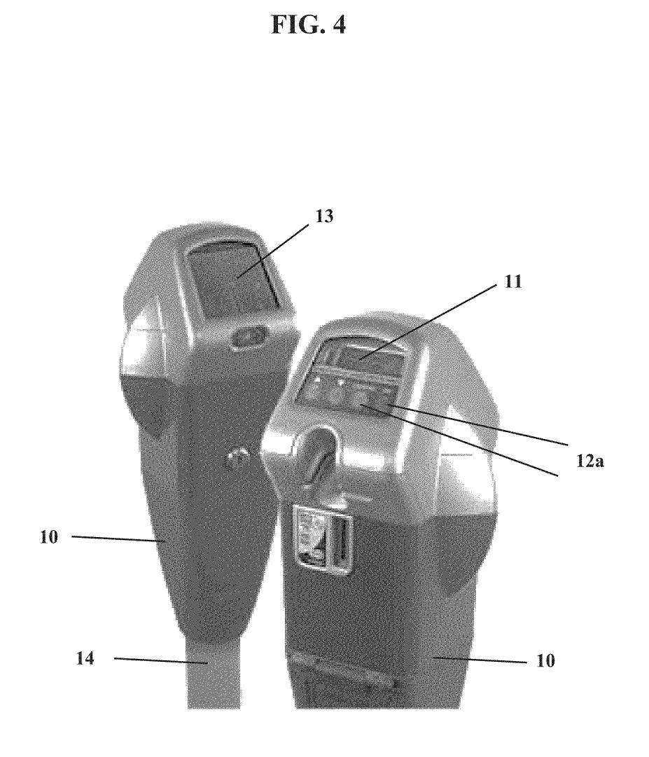

Referring to the drawing of FIG. 4, the parking meter head 10 in this exemplification is configured on its front side to include a screen 11 and various keys or buttons 12a for interfacing with users. The parking meter head 10 is configured on its rear side to include a solar panel 13. The solar panel 13 is proximate to the top portion of the head 10 of the parking meter. The parking meter head 10 is engaged with a pole 14 to allow vertical positioning of the parking meter. This exemplification is shown without the housing structure.

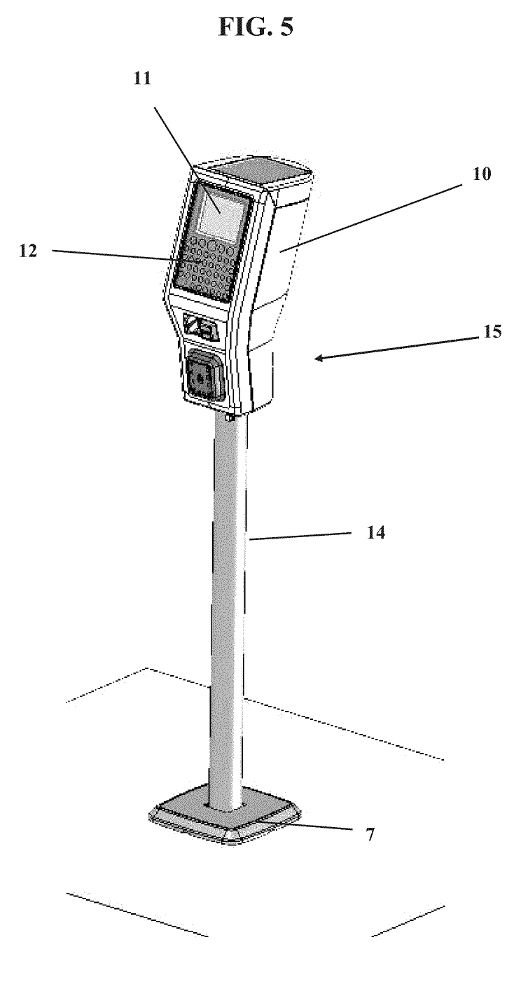

Referring to the drawing of FIG. 5, the parking meter 15 in this exemplification is configured to include a screen 11 and a keyboard 12 for interfacing with users. The parking meter head 10 is configured to include a solar panel 13 that is positioned on the top portion of the head. The parking meter head 10 is engaged with a pole 14 to allow vertical positioning of the parking meter. The parking meter pole 14 is engaged with a base 7 to enhance stabilisation of the parking meter. This exemplification is shown without the housing structure.

The solar panel charging system may be assembled and used as described herein. For example, the housing may be installed onto a parking meter pole in such a way as to facilitate an electrical communication between one or more solar panels on the housing and a power source for the parking meter. In turn, the electrical communication from the one or more solar panels can be activated to provide a power supply for the parking meter. As already noted, the electrical communication between the solar panel(s) and the parking meter may comprise an electrically conductive wire or wireless communication. The electrical communication may be controlled by one or more solar panel controllers, or by a main controller for the parking meter. The one or more solar panels on the housing may provide the sole supply of power or a supplementary supply of power for the parking meter. The one or more solar panels on the housing may also provide a supplementary supply of solar power for the parking meter. This may be useful when the parking meter head includes one or more solar panels. The power source fed by the solar panel(s) can include one or more batteries, or other types of power storage devices as described herein.

In a particular embodiment, a cuboid housing with elongated vertical sides is constructed from an aluminium extrusion. An aluminium base is constructed separately. The housing includes slots for fitting two or four vertically mounted solar panels. Two solar panels are fitted to the housing by sliding onto the slots. The electrical wiring for the solar panels is drawn through the interior to the housing towards the top portion of the housing. The head of the parking meter is removed, if needed, and the base is slid over the parking meter pole. The housing is then slid over the parking meter pole, i.e., as a solar sleeve. The solar sleeve is then engaged with the base. The solar panel wiring in housing is then engaged with the solar sleeve controller. The solar sleeve controller is then engaged with the main controller for the parking meter. The solar sleeve controller is switched on, and the main controller is switched on. The energy input from the housing provides a regulated power supply for the parking meter. The head of the parking meter is re-attached and ready for user interaction.

All references, including patents and patent applications, cited in this specification are hereby incorporated by reference. No admission is made that any reference constitutes prior art. Nor does discussion of any reference constitute an admission that such reference forms part of the common general knowledge in the art, in New Zealand or in any other country.

Persons of ordinary skill can utilise the disclosures and teachings herein to produce other embodiments and variations without undue experimentation. All such embodiments and variations are considered to be part of this invention.

Accordingly, one of ordinary skill in the art will readily appreciate from the disclosure that later modifications, substitutions, and/or variations performing substantially the same function or achieving substantially the same result as embodiments described herein may be utilised according to such related embodiments of the present invention. Thus, the invention is intended to encompass, within its scope, the modifications, substitutions, and variations to processes, manufactures, compositions of matter, compounds, means, methods, and/or steps disclosed herein.

What is claimed is:

1. A solar panel energy system for a parking meter comprising:
a housing that is configured as a sleeve for a parking meter pole or post,
wherein the housing comprises a plurality sides,
wherein at least one of the plurality of sides comprises a solar panel for absorbing solar energy,
wherein the solar panel is in electrical communication with a power source for the parking meter,
wherein the electrical communication is regulated by a controller, and
wherein the electrical communication from the solar panel provides a power supply for the parking meter.

2. The solar panel energy system of claim 1, wherein the housing comprises one or more of: a) at least four vertical or essentially vertical sides.

3. The solar panel energy system of claim 1, wherein the housing comprises at least two solar panels.

4. The solar panel energy system of claim 1, wherein the housing comprises one or more slots for each solar panel.

5. The solar panel energy system of claim 1, wherein the electrical communication comprises an electrically conductive wire or wireless communication.

6. The solar panel energy system of claim 1, wherein the electrical communication is regulated by a) a solar panel controller; or b) a main controller for the parking meter.

7. The solar panel energy system of claim 1, wherein the solar panel provides a) a sole supply of power for the parking meter; or b) a supplementary supply of power for the parking meter.

8. The solar panel energy system of claim 1, wherein the power source for the parking meter comprises one or more batteries.

9. The solar panel energy system of claim 1, wherein the housing comprises extruded aluminium.

10. The solar panel energy system of claim 1, wherein the housing comprises extruded plastic.

11. The solar panel energy system of claim 1, wherein the housing is engaged with a base.

12. A method for providing a power supply for a parking meter comprising:
i) installing a housing onto a parking meter pole or post,
wherein the housing is configured as a sleeve for the parking meter pole or post,
wherein the housing comprises a plurality sides,
wherein at least one of the plurality of sides comprises a solar panel for absorbing solar energy, and
ii) facilitating an electrical communication between the solar panel and a power source for the parking meter,
wherein the electrical communication is regulated by a controller, and
wherein the electrical communication from the solar panel provides a power supply for the parking meter.

13. The method of claim 12, wherein the housing comprises at least two solar panels.

14. The method of claim 12, wherein the electrical communication comprises an electrically conductive wire or wireless communication.

15. The method of claim 12, wherein the electrical communication is regulated by a solar panel controller.

16. The method of claim 12, wherein the electrical communication is regulated by a main controller for the parking meter.

17. The method of claim 12, wherein the solar panel provides a sole supply of power for the parking meter.

18. The method of claim 12, wherein the solar panel provides a supplementary supply of power for the parking meter.

19. The method of claim 12, wherein the power source for the parking meter comprises one or more batteries.

20. The method of claim 12, wherein the parking meter comprises one or more additional solar panels on a head portion of the parking meter.
